(19) United States
(12) Patent Application Publication
(10) Pub. No.: US 2007/0234828 A1
(43) Pub. Date: Oct. 11, 2007

(54) ROLLER AND FOUR WAY ROLLER ASSEMBLY

(75) Inventors: Chun-Chung Huang, Taipei (TW); Zhan-Ling Liu, Suzhou (CN)

Correspondence Address: QUINTERO LAW OFFICE, PC, 2210 MAIN STREET, SUITE 200, SANTA MONICA, CA, 90405, US

(73) Assignee: DARFON ELECTRONICS CORP., TAOYUAN (TW)

(21) Appl. No.: 11/688,780

(22) Filed: Mar. 20, 2007

(30) Foreign Application Priority Data
Mar. 22, 2006 (TW) TW95109880

(51) Int. Cl. G01M 19/00

(52) U.S. Cl. 73/865.3

(57) ABSTRACT

A roller and a four way roller assembly is disclosed. The roller includes an axle, a wheel, and at least a flexible connecting portion. The flexible portion connects to the axle and the wheel, thereby the axle moves in the wheel. The four way roller assembly includes a base, a roller container and a roller. The roller container is movably installed on the base. The roller rotates in the roller container via the axle. The axle presses a first sensor on the base.

### BACKGROUND OF THE INVENTION

1. Field of the Invention

The invention relates to a roller and a four way roller assembly, and more particularly to a roller and a four way roller assembly applied to an input device.

2. Description of the Related Art

A conventional roller is shown in FIGS. 1 and 2. The roller 10 comprises a first wheel 11, a flexible axle 12, an encoder 13, a second wheel 14, and a sensor 15. The flexible axle 12 is connected to the encoder 13 and the second wheel 14. The flexible axle 12 installed on a supporter 16 is pressed to flexibly bend, initializing the sensor 15 via the second wheel 14 for conducting electricity.

The conventional roller 10 only provides downward pressure to drive the sensor 15.

### BRIEF SUMMARY OF INVENTION

A detailed description is given in the following embodiments with reference to the accompanying drawings. The invention provides a roller and a four way roller assembly applied to an input device. The roller comprises an axle, a wheel and at least a flexible connecting portion. The flexible connecting portion is connected to the axle and the wheel allowing the axle to move freely corresponding to the wheel.

The four way roller assembly comprises a base, a roller holder rotatably installed on the base, and a wheel. The roller holder comprises an opening. The wheel comprises a wheel having a cannular portion, a flexible connecting portion, a first axle and a second axle. The first axle passes through the cannular portion. The flexible connecting portion is connected to the first axle and the wheel. The second axle is pivoted to the opening. The roller rotates corresponding to the roller holder via the fist axle and the second axle. The first axle initializes the first sensor.

### BRIEF DESCRIPTION OF DRAWINGS

The invention can be more fully understood by reading the subsequent detailed description and examples with references made to the accompanying drawings, wherein:

FIGS. 1 and 2 are schematic views of a conventional roller;

FIG. 3 is a vertical view of a roller of the invention;

FIG. 4 is a lateral view of a roller of the invention;

FIG. 5 is a schematic view of a roller of the invention;

FIG. 6 is a schematic view of a roller holder of the invention;

FIGS. 7A-7D are schematic views of a flexible connecting portion generating deformation subsequent to exertion of force on the roller of the invention; and

FIG. 8 is a rear view of a roller of the invention.

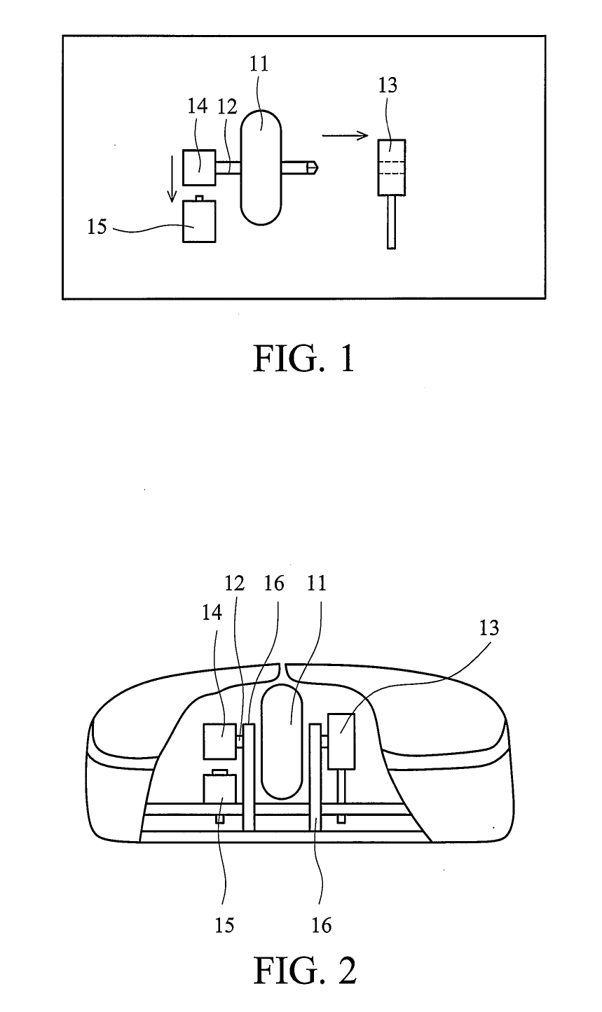

### DETAILED DESCRIPTION OF INVENTION

The following description is of the best-contemplated mode of carrying out the invention. This description is made for the purpose of illustrating the general principles of the invention and should not be taken in a limiting sense. The scope of the invention is best determined by reference to the appended claims.

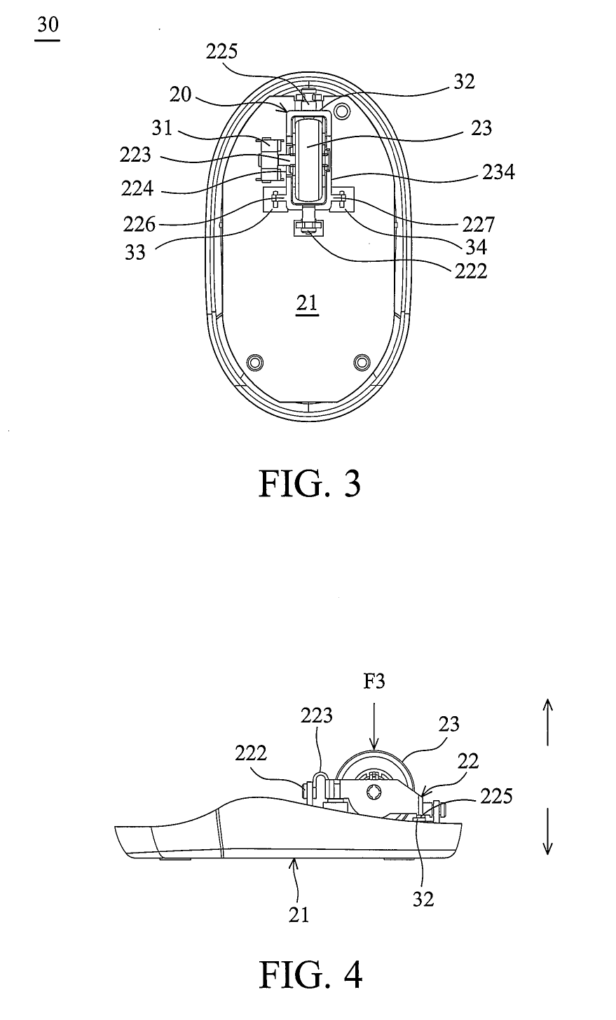

FIGS. 3 and 4 show the four way roller assembly 20 applied to an input device 30. The input device 30 comprises a first sensor 31, a second sensor 32, a third sensor 33 and the fourth sensor 34. In this embodiment, the first sensor 31 may be an encoder. The second, third, and fourth sensors 32, 33, and 34 are switches. The four way roller assembly 20 comprises a base 20, a roller holder 22 and a roller 23.

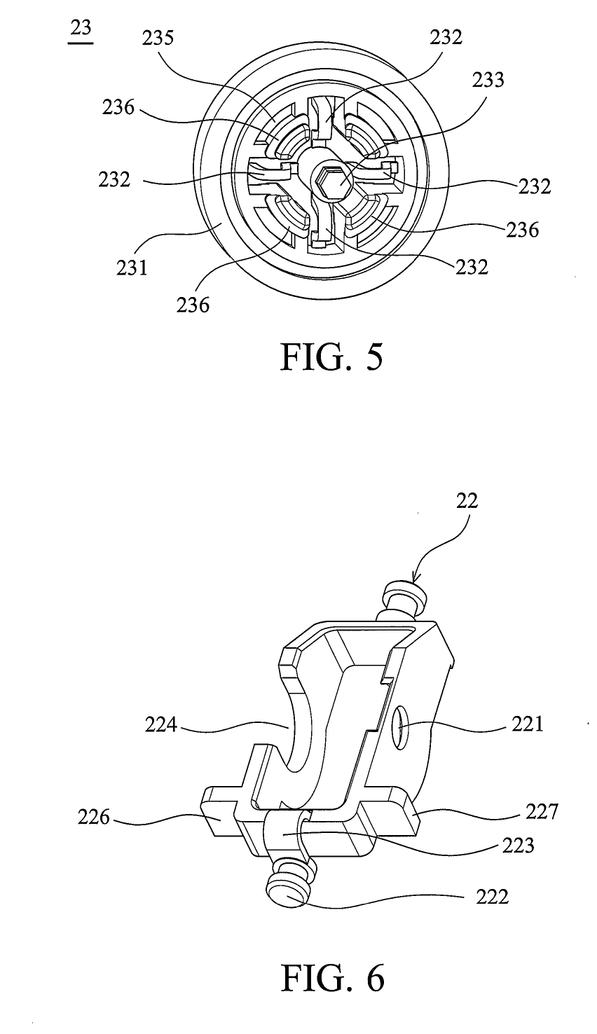

Referring to FIGS. 3 and 5, the roller 23 comprises a wheel 231, a plurality of flexible connecting portions 232 and a second axle 234 (shown in FIG. 3). The wheel 231 comprises a cannular portion 235 for containing the first axle 233. In this embodiment, the flexible connecting portions 232 are radially connected to the fist axle 233 and the wheel 231. The second axle 234 extends from an inner side of wheel 231 to the outside. Additionally, the second axle 234 is formed by a plurality of connectors 236.

Please referring to FIGS. 3 and 6, the roller holder 22 comprises an opening 221, a rotating portion 222, a flexible portion 223, a hole 224, a first protrusion 225, a second protrusion 226 and a third protrusion 227. The second axle passes through and rotates in the opening 221. The rotating portion 222 passes through and rotates on the base 21. The flexible portion is connected to the roller holder 22 and the rotating portion 222.

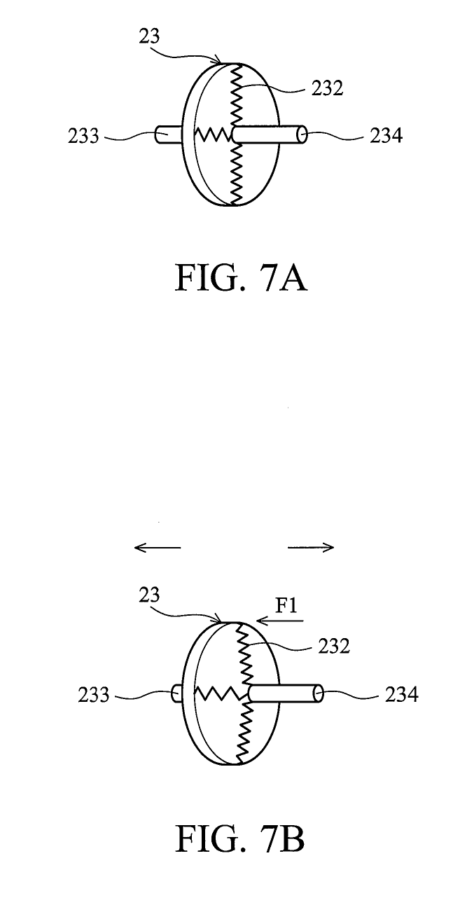

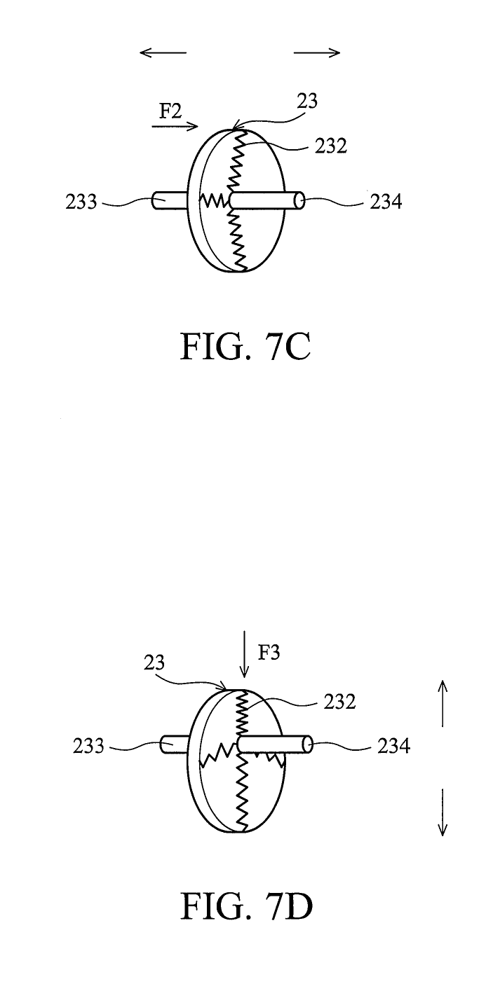

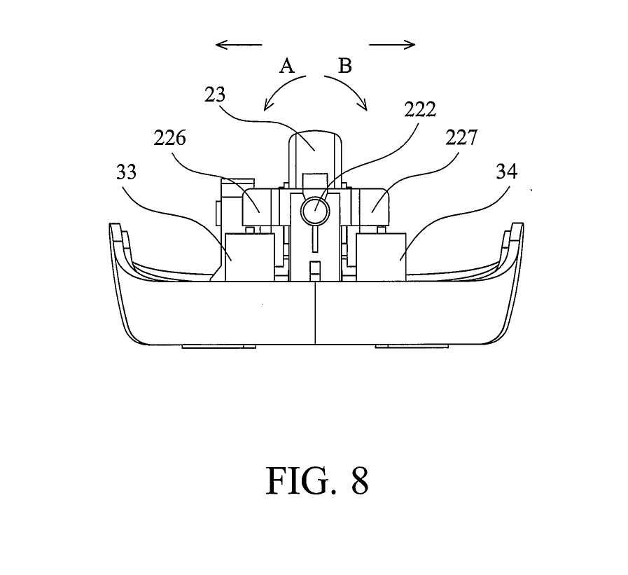

FIGS. 3, 7A-7C and 8, show the rotating portion 222 of the four way roller assembly 20 pivoted on the base 21, thus, the roller holder 22 selectively swings in a first direction (indicated by arrow A on the left side) or in a second direction (indicated by arrow B on the right side). The second protrusion 226 of the roller holder 22 corresponds to the third sensor 33 and the third protrusion 227 of the roller holder 22 corresponds to the fourth sensor 34. When the wheel 23 is pushed by a force F₁ (shown in FIG. 8), the flexible connecting portions 232 of the wheel 23 slightly protrude rightward, and then the wheel 23 drives the roller holder 22 to swing in the first direction (leftward) initializing the third sensor 33 via the second protrusion 226. Conversely, when the wheel 23 is pushed by a force F₂ (shown in FIG. 8), the flexible connecting portions 232 of the wheel 23 slightly protrude leftward, and the wheel 23 then drives the roller holder 22 to swing in the second direction (rightward) initializing the fourth sensor 34 via the third protrusion 227. In this embodiment, subsequent to motive force being exerted on the wheel 23, the flexible connecting portions 232 generate a back force restoring the wheel 23 to an initial state (shown in FIG. 7).

Please refer to FIGS. 3, 4, 7A and 7D, the flexible portion of the four way roller assembly 20 is connected to the roller holder 22 and the rotating portion 222. When a force F₃ acts on wheel 23, the first axle 233 in hole 224 is pushed downward. The flexible connecting portions 232 of the wheel 23 and the flexible portion 223 then deforms (shown in FIG. 7D) the roller holder 22 to move downward. Thus, the first protrusion 225 initializes the second sensor 32. In this embodiment, subsequent to motive force being exerted on the wheel 23, the flexible connecting portions 232 generate a back force restoring the wheel 23 in an initial state (shown in FIG. 7A). Similarly, subsequent to motive force being exerted on the roller holder 22, the flexible portion 223 generates a back force restoring the roller holder 22 in an initial position.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A roller, applied to an input device, comprising:
an axle;
a wheel;
at least a flexible connecting portion, the flexible connecting portion connecting to the axle and the wheel, wherein the axle passes through the wheel and moves freely in the wheel.

2. The roller as claimed in claim 1, wherein the roller comprises a plurality of flexible connecting portions radially connected to the axle and the wheel.

3. A four way roller assembly, applied to an input device comprising a first sensor, the four way roller assembly comprising:
a base;
a roller holder rotatably disposed on the base, comprising an opening; and
a roller comprising:
a wheel comprising a cannular portion;
a flexible connecting element;
a first axle disposed in the cannular portion, wherein the flexible connecting element is connected to the first axle and the wheel; and
a second axle pivoted to the opening;
wherein the roller rotates corresponding to the roller holder via the fist axle and the second axle; and
the first axle initializes the first sensor.

4. The four way roller assembly as claimed in claim 3, wherein first sensor comprises an encoder.

5. The four way roller assembly as claimed in claim 3, wherein the roller comprises a plurality of flexible connecting portions radially connected to the fist axle and the wheel.

6. The four way roller assembly as claimed in claim 3, wherein the rotation direction of the roller holder is perpendicular to the rotation direction of the roller.

7. The four way roller assembly as claimed in claim 3, wherein the roller holder comprises a rotating portion and a flexible portion; the rotating portion is pivoted to the base; the flexible portion is connected to the roller holder and the rotating portion.

8. The four way roller assembly as claimed in claim 3, wherein the roller holder further comprises a hole and a first end; the input device further comprises a second sensor; when the first axle presses downward, the second sensor is initialized.

9. The four way roller assembly as claimed in claim 8, wherein the second sensor comprises a switch.

10. The four way roller assembly as claimed in claim 3, wherein the second axle comprises a plurality of connectors and extends from an inner side of wheel to the outside.

11. The four way roller assembly as claimed in claim 3, wherein the roller holder comprises a second protrusion and a third protrusion; the roller holder selectively rotates toward one of a first direction and a second direction; the input device further comprises a third sensor and a fourth sensor; when the roller holder rotates toward the first direction, the second protrusion initializes the third sensor; when the roller holder rotates toward the second direction, the third protrusion initializes the fourth sensor.

12. The four way roller assembly as claimed in claim 11, wherein the third sensor and the fourth sensor comprise a switch respectively.
